(19) United States
(12) Patent Application Publication
(10) Pub. No.: US 2023/0373568 A1
(43) Pub. Date: Nov. 23, 2023

(54) FLOORING FOR A VEHICLE, AS WELL AS A METHOD OF MOUNTING SUCH FLOORING IN A MOTOR VEHICLE

(71) Applicant: AUTOPRODUCTS APS, Herming (DK)

(72) Inventor: Finn Hansen, Augustenborg (DK)

(21) Appl. No.: 18/261,297

(22) PCT Filed: Jan. 6, 2022
(86) PCT No.: PCT/EP2022/050205

§ 371 Date: Jul. 13, 2023

(30) Foreign Application Priority Data
Jan. 15, 2021 (DK) PA 2021 00045

(51) Int. Cl. B62D 25/20

(52) U.S. Cl. CPC B62D 25/20

(57) ABSTRACT

Lightweight flooring is shown for mounting to at least a part of the bottom of a passenger vehicle. The flooring includes elongate plate elements of a first type (120) for engaging elongate plate elements of a second type (130) at side edges (133) thereof. Rail elements (126) are provided in an upper part (125) of the plate elements of the first type (120) for engaging with a mounting part of a seat positioned for installation on the upper side (101) of the flooring. The plate elements of the second type (130) are configured as a sandwich panel including a top plate (134), a bottom plate (135), and a honeycomb structure (136) disposed between the top plate (134) and the bottom plate (135). A method for mounting such flooring in a motor vehicle is shown as well.

### TECHNICAL FIELD OF THE INVENTION

The present invention relates to a flooring for a passenger vehicle.

### BACKGROUND OF THE INVENTION

It is well-known to provide seats in a vehicle, such as a motor vehicle or airplane, that are mounted in position on rails, or which are adapted to engage a track on the floor of the vehicle and lockable in place by way of a pair of spaced apart plates, which may be moved apart to bias the plates in a locking position. A special flooring for such a vehicle is necessary to provide the necessary strength and for accommodating the rails. A general problem is that the assembly and mounting time for the flooring in the vehicle is relatively long. As an example, the time to assemble and mount a flooring in the passenger compartment (about 5 m²) of a Mercedes Sprinter 316 CDi A2 Tourer may be several hours. Some flooring solutions are built in the vehicle, while others are assembled first and mounted subsequently. The latter solutions have problems with bending and deforming during the mounting operation when it is lifted into place in the vehicle, and regulations may require that several workers lift the flooring into place due to the relatively heavy weight of the assembled flooring. As an example, the weight of an assembled flooring of about 5 m² for a Mercedes Sprinter 316 CDi A2 Tourer may be 100-150 kg, depending on the type.

### DESCRIPTION OF THE INVENTION

It is an object of the present invention to overcome the above-mentioned problems. The present invention provides a solution where the assembly and mounting time is markedly reduced, the risk of the flooring deforming during the mounting operation is removed, and fewer workers are needed for the mounting operation.

A first aspect relates to a flooring for a vehicle, said flooring having dimensions suitable for covering the bottom, or at least a part of the bottom, of an interior compartment of said vehicle, said flooring having an upper side adapted for the mounting of at least one seat, and a bottom side adapted for fastening to said bottom of said interior compartment of said vehicle, said flooring comprising in an alternating order:
elongate plate elements of a first type and with a top face, a bottom face opposite to said top face, and two opposing side edges; and
elongate plate elements of a second type and with a top face, a bottom face opposite to said top face, and two opposing side edges;

wherein at least one of said side edges of said plate element of a second type is configured to engage with one of said plate elements of a first type;

wherein said plate elements of a first type are flanked along its side edges with a plate element of a second type;

wherein said top face of said plate elements of a first type comprises a rail element adapted for engaging with said seat;

wherein said plate elements of a second type are configured as a sandwich panel including a top plate, a bottom plate, and a honeycomb structure disposed between said top and bottom plates.

In the present context, the term “seat” also contemplates a wheelchair with or without a passenger.

In the present context, the term “honeycomb structure” also contemplates cellular structures that mimic that of a honeycomb, e.g., where some of the walls between neighboring hexagons have been omitted to form polygons, such as cellular structures with fourteen-cornered cells, e.g., as disclosed in U.S. Ser. No. 10/220,881, hereby incorporated by reference. These embodiments are used to reduce the weight further but retaining the rigidity of the sandwich panel. In one or more embodiments, the honeycomb structure comprises a plurality of cells, each cell of the plurality of cells having a fourteen-cornered cross section comprising fourteen sides and fourteen corners, wherein a shape of each cell of the plurality of cells includes a central portion and four lobes extending outward from the central portion.

The rigidity provided by the honeycomb structure in the plate elements of a second type secures that the flooring will not deform when lifted. Furthermore, the honeycomb structure allows for a thinner construction, and an option for using lightweight materials relative to metals, such as polymers, thereby also reducing the overall weight of the flooring that further reduces the risk of deformation, thereby eliminating the need for stiffeners mounted across the flooring, but also allows for fewer workers needed for the mounting operation. The overall lower weight of the flooring compared to floorings currently on the market also makes such floorings especially suitable for electric vehicles, such as automobiles, both in terms of the need for lightweight components, but also to be able mount the flooring to the bottom of an interior compartment of said vehicle by adhesives, as batteries are often placed directly beneath said bottom, thereby making it very difficult to find space for bolting the flooring to said bottom. As an example, the weight of an assembled flooring according to the present invention for a Mercedes Sprinter 316 CDi A2 Tourer may be reduced to 60-70 kg.

In one or more embodiments, the plate element of a first type comprises a base part and an upper part made in one piece.

In one or more embodiments, the upper part forms said rail element.

In one or more embodiments, the base part and upper part together defines a pair of elongate grooves flanking said rail element.

In one or more embodiments, the grooves are each adapted for receiving a side edge of said plate element of a second type.

In one or more embodiments, the flooring does not comprise stiffeners mounted across said plate elements of a first and second type. Due to the rigidity of the flooring according to the present invention, such stiffeners, e.g., elongate plates, are not necessary, and the mounting of such only prolong the assembly time.

In one or more embodiments, the plate elements of a first type are made of a metal, such as, and preferably, aluminum.

In one or more embodiments, the plate elements of a second type are made of a polymeric material, such as polypropylene. Preferably, only the honeycomb structure is made from polypropylene, while the top and bottom plates are made of fiber-reinforced plastic (FRP), wood-plastic composites (WPC), other polymers, such as polyethylene (PE), or polycarbonate (PC), or the like, graphite. Wood-plastic composites are composite materials made of wood fiber/wood flour and a thermoplastic material, such as PE, PP, PVC, or PLA. Fiber-reinforced plastic (FRP) is a composite material made of a polymer matrix reinforced with fibers. The fibers are usually made of glass (in fiberglass), carbon (in carbon fiber reinforced polymer), aramid, or basalt. Preferably, the top and bottom plates are made of fiber-reinforced plastic (FRP) due to its mechanical strength.

In one or more embodiments, the plate elements of a first type are made of a metal, such as aluminum, and wherein the plate elements of a second type are made of a polymeric material, such as polypropylene. This construction is optimal with regards to rigidity and weight.

In one or more embodiments, the plate elements of a first type are made of a metal, such as aluminum, and wherein the honeycomb structure is made from polypropylene, while the top and bottom plates are made of fiber-reinforced plastic (FRP). This construction is optimal with regards to rigidity and weight.

In one or more embodiments, the top face of said elongate plate elements of a second type is configured with a nonslip surface, such as a rough, corrugated, and/or grooved surface. This configuration provides a flooring where the user is less prone to slip on the surface.

In one or more embodiments, the honeycomb structure comprises a plurality of hexagonal unit cells configured such that facing sides of each of the hexagonal unit cells are parallel to each other.

In one or more embodiments, the honeycomb structure comprises a plurality of sheets having concave and convex parts formed in a trapezoidal fashion, such that the said sheets are not aligned with one another.

In one or more embodiments, the honeycomb structures are air filled.

Each of the hexagonal unit cells may be configured such that a size of a hexagon contacting the top plate is greater than that of a hexagon contacting the bottom plate.

The honeycomb structure may be configured such that sizes of hexagonal unit cells located at a middle portion of the plate elements of a second type are less than those of hexagonal unit cells located at left and right portions of said plate elements of a second type.

The honeycomb structure may include a first type of hexagonal unit cells disposed at a middle portion of the plate elements of a second type, and a second type of hexagonal unit cells disposed at left and right portions of said plate elements of a second type, and wherein said first type of hexagonal unit cells have a relatively greater rigidity than said second type of hexagonal unit cells.

A side termination member may be attached to a circumference of the sandwich honeycomb panel.

The top and bottom plates of the sandwich panel may have a thickness of 2 mm or less, such as within the range of 0.1-1.9 mm, e.g., within the range of 0.2-1.8 mm, such as within the range of 0.3-1.7 mm, e.g., within the range of 0.5-1.6 mm, such as within the range of 0.6-1.5 mm, e.g., within the range of 0.7-1.4 mm, such as within the range of 0.8-1.3 mm, e.g., within the range of 0.9-1.2 mm, preferably within the range of 0.5-1.5 mm.

In one or more embodiments, the plate elements of a second type have a height of within the range of 0.5-4 cm, and a density of within the range of 1-6 kg per m². Preferably, the plate elements of a second type have a height of within the range of 0.5-2 cm, and a density of within the range of 1-3.5 kg per m².

In one or more embodiments, the flooring has a height within the range of 0.5-4 cm, preferably within the range of 0.5-2 cm, and a density of within the range of 2-6 kg per m², preferably within the range of 3-6 kg per m². The total density of the flooring is higher than the density of the plate elements of a second type, as the density of the plate elements of a first type is relatively high due to the material preferably being a metal, such as aluminum. Preferably, the plate elements of a second type are hollow extruded profiles, in order to reduce the overall weight.

In one or more embodiments, the plate element of a first type comprises a base part and an upper part, wherein said upper part comprises said rail element, and wherein said base part and upper part together defines a pair of elongate grooves flanking said rail element, said grooves each adapted for receiving a side edge of said plate element of a second type. This configuration allows for an easier assembly of the flooring.

In one or more embodiments, a plate element of a second type together with two flanking plate elements of a first type defines an air-filled void between the base part and the bottom face of the plate element of a second type.

A second aspect relates to a method of mounting flooring in a motor vehicle with a vehicle body and an interior compartment with a bottom; the method comprising:
providing dimensions of said bottom in said interior space;
assembling or providing a flooring according to said dimensions, or at least to a part of said dimensions, said flooring being and according to the present invention;
inserting said flooring into said interior space; and
permanently or releasably attaching said flooring to said bottom.

In one or more embodiments, wherein when said bottom comprises a corrugated surface comprising a series of parallel ridges and grooves, wherein prior to said insertion of said flooring, filling the grooves of said corrugated surface with an adhesive, said adhesive further aiding in permanently attaching said flooring to said bottom.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1B shows a flooring according to various embodiments of the present invention.

FIG. 1A shows a cross-sectional view of section B-B of FIG. 1.

FIG. 2 shows a closeup view of detail A of FIG. 1, where the honeycomb structure is exposed.

FIG. 3 shows a closeup view of detail B of FIG. 1A.

FIG. 4 shows a closeup view of detail C of FIG. 1A.

FIG. 5 shows a closeup view of detail D of FIG. 1B, where the honeycomb structure is exposed.

FIG. 6B shows a flooring according to various embodiments of the present invention.

FIG. 6A shows a cross-sectional view of section B-B of FIG. 1.

FIG. 7 shows a closeup view of detail B of FIG. 6A.

### DETAILED DESCRIPTION OF THE INVENTION

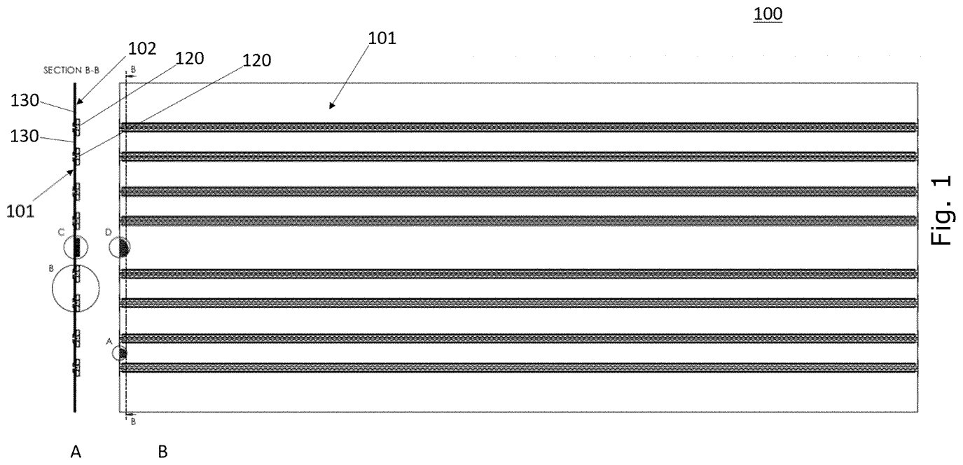

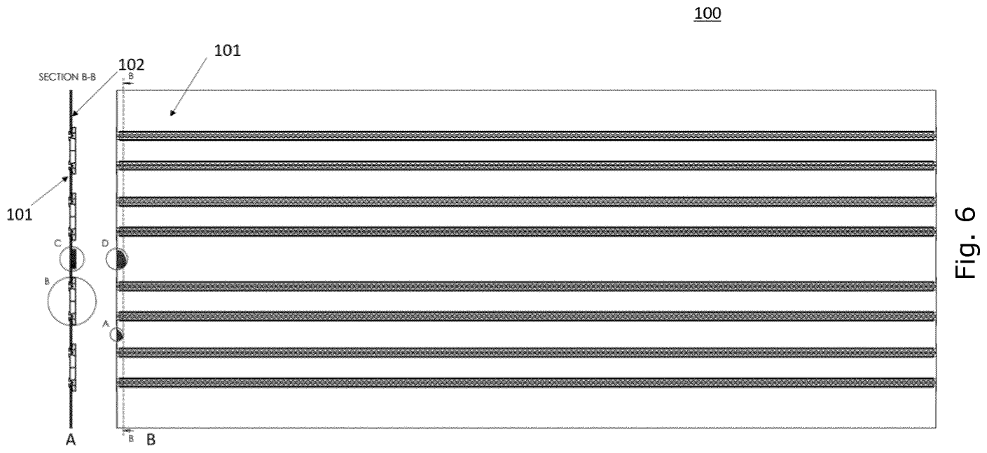

The following description is to be seen as a non-limiting example of a flooring according to various embodiments of the present invention. The specific examples are intended for two parallel arranged seat rails (four sets are shown in FIGS. 1 and 6), but the invention contemplates embodiments suitable for a single seat rail or for multiple seat rails, such as three seat rails. FIG. 1B shows a top view of a flooring 100 according to various embodiments of the present invention. As can be seen from the cross-sectional view B-B in FIG. 1A, the flooring 100 are made from alternating plate elements of a first 120 (eight plates) and a second 130 type (nine plates), and with an upper side 101 and a bottom side 102.

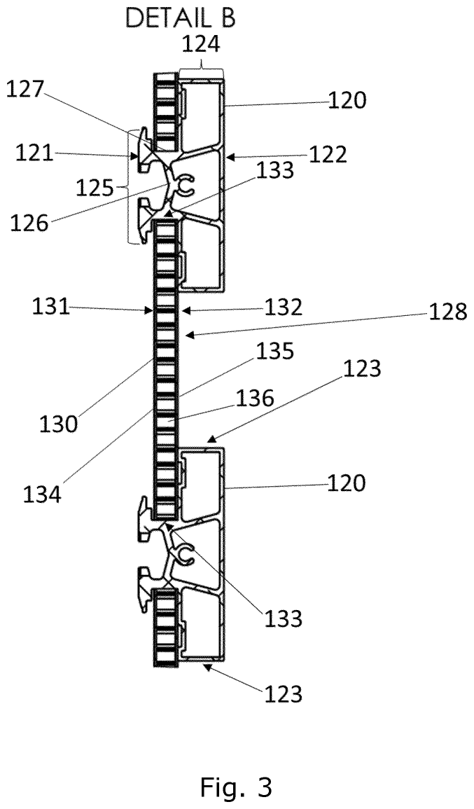

The plate elements of a second type 130 are configured as a sandwich panel including a top plate 134, a bottom plate 135, and a honeycomb structure 136 disposed between said top 134 and bottom 135 plates (FIG. 3).

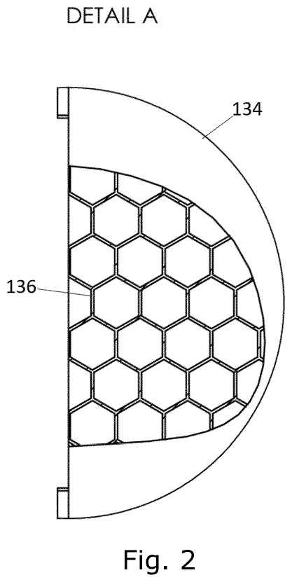

FIG. 2 shows a close-up view of detail A in FIG. 1, where part of a top plate 134 is removed to show the underlaying honeycomb structure 136.

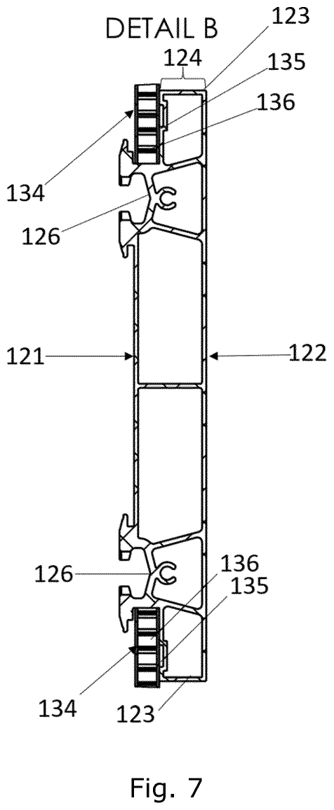

FIG. 3 shows a closeup view of detail B of FIG. 1, showing a plate element of a second type 130 flanked by two plate elements of a first type 120. The plate elements of a first type 120 each comprises a top face 121, a bottom face 122, and two side faces 123. A plate element of a first type 120 may be divided into a base part 124, and an upper part 125. The upper part 125 comprises one rail element 126 adapted for engaging with one side of a said seat (not shown) to be mounted within the vehicle (not shown). A second rail element will be positioned in another plate element of a first type at a distance therefrom, which will be adapted for engagement with the other side of said seat. Alternatively, as seen in FIGS. 6 and 7, the plate element of a first type 120 may comprise two rail elements 126 adapted for engaging with one side of a said seat (not shown) to be mounted within said vehicle (not shown). The base part 124, and upper part 125 together defines a pair of elongate grooves 127 flanking said rail element 126. The grooves 127 are each adapted for receiving a side edge 133 of a plate element of a second type 130. In general, a plate element of a second type 130 together with two flanking plate elements of a first type 120 may define an air-filled void 128 between the base part 124 and the bottom face 132 of the plate element of a second type 130.

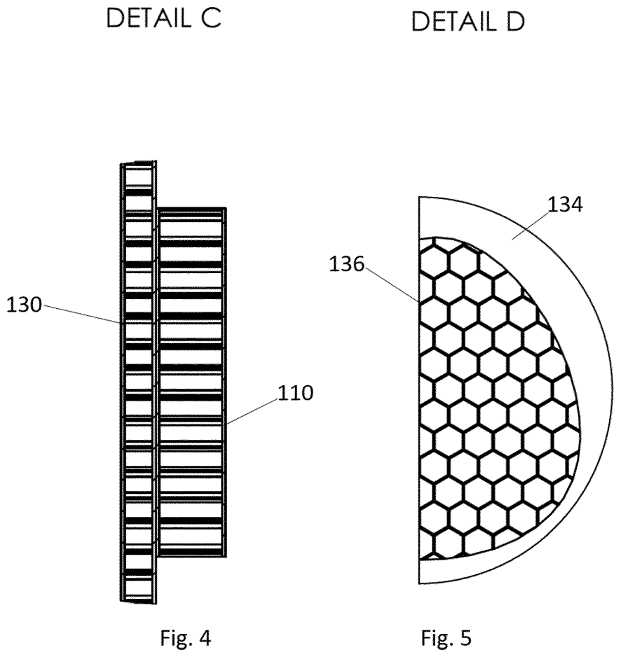

FIG. 4 shows a closeup view of detail C of FIG. 1A. The shown plate element of a second type 130 is reinforced with a plate element of a third type 110 attached, e.g., welded or glued, to its bottom face 132, here shown having the same sandwich structure as the plate element of a second type 130. This configuration is used to avoid deformation in situations where the plate element of a second type 130 is particularly wide. The plate element of a third type 110 then functions as a pillar reaching the bottom of the interior compartment of said vehicle.

FIG. 5 shows a closeup view of detail D of FIG. 1B, where the honeycomb structure 136 is exposed.

### REFERENCES

100 Flooring
101 Upper side
102 Bottom side
110 Plate element of a third type
120 Plate element of a first type
121 Top face
122 Bottom face
123 Side edge
124 Base part
125 Upper part
126 Rail element
127 Groove
128 Void
130 Plate element of a second type
131 Top face
132 Bottom face
133 Side edge
134 Top plate
135 Bottom plate
136 Honeycomb structure

1. A flooring (100) for a vehicle with a bottom of an interior compartment of said vehicle, said flooring (100) having flooring dimensions suitable for covering the bottom, or at least a part of the bottom of said interior compartment of said vehicle, said flooring (100) having an upper side (101) adapted for the mounting of at least one seat, and a bottom side (102) adapted for fastening to said bottom of said interior compartment of said vehicle, said flooring (100) comprising in an alternating order:
elongate plate elements of a first type (120) and with a top face (121), a bottom face (122) opposite to said top face (121), and two opposing first type side edges (123); and
elongate plate elements of a second type (130) and with a top face (131), a bottom face (132) opposite to said top face (131), and two opposing second type side edges (133);
wherein at least one of said two opposing second type side edges (133) of said plate element of said second type (130) is configured to engage with one of said plate elements of said first type (120);
wherein one or more of said plate elements type (120) are flanked along said two opposing first type side edges (123) with corresponding one or more plate elements of said second type (130);
wherein said top face (121) of said plate elements of said first type (120) comprises a rail element (126) adapted for engaging with said at least one seat;
wherein said plate elements of said second type (130) are each configured as a sandwich panel including a top plate (134), a bottom plate (135), and a honeycomb structure (136) disposed between said top plate (134) and said bottom (135) plate (135).

2. The flooring (100) according to claim 1, wherein said plate elements of said first type (120) are made of a metal, and wherein said honeycomb structure (136) is made from polypropylene, while at least one of said top plate (134) and said bottom plate (135), are made of fiber-reinforced plastic.

3. The flooring (100) according to claim 1, wherein said top face (131) of said elongate plate elements second of said second type (130) is configured with a nonslip surface.

4. The flooring (100) according to claim 1, wherein each plate element of said plate elements of said first type (120) comprises a base part (124) and an upper part (125), wherein said upper part comprises said rail element (126), and wherein said base part (124) and upper part (125) together define a pair of elongate grooves flanking said rail element (126), each elongate groove (127) of said pair of elongate grooves adapted for receiving a side edge (133) of a corresponding plate element of said second type (130).

5. The flooring (100) according to claim 4, wherein a plate element of said second type (130) together with two flanking plate elements of said first type (120) define an air-filled void (128) between said base part (124) and said bottom face (132) of said plate element of said second type (130).

6. The flooring (100) according to claim 1, wherein said plate elements of said second type (130) have a height of within a range of 0.5-2 cm, and a density of within a range of 1-3.5 kg per m².

7. The flooring (100) according to claim 1, said flooring (100) having a height within a range of 0.5-4 cm, and a density of within a range of 3-6 kg per m².

8. The flooring (100) according to, claim 1, wherein said flooring (100) does not comprise stiffeners mounted across said plate elements of said first type (120) and said plate elements of said second type (130).

9. The flooring (100) according to claim 1, wherein said plate element of said first type (120) comprises a base part (124) and an upper part (125).

10. The flooring (100) according to claim 9, wherein said upper part (125) forms said rail element (126).

11. The flooring (100) according to claim 10, wherein said base part (124) and said upper part (125) together define a pair of elongate grooves (127) flanking said rail element (126).

12. The flooring (100) according to claim 11, wherein said grooves (127) each are shaped to receive a corresponding side edge (133) of said plate element of said second type (130).

13. The flooring (100) according to claim 1, wherein said plate element of said second type (130) together with two flanking plate elements of said plate element of said first type (120) define an air-filled void (128) between said base part (124) and said bottom face (132) of said plate element of said second type (130).

14. A method of mounting said flooring (100) of claim 1 in said motor vehicle, said method comprising:
providing bottom dimensions of said bottom in said interior space;
assembling or providing said flooring (100) with said flooring dimensions provided according to said bottom dimensions, or at least to a part of said bottom dimensions;
inserting said flooring (100) into said interior space; and
permanently attaching said flooring (100) to said bottom.

15. The method according to claim 14, wherein when said bottom comprises a corrugated surface comprising a series of parallel ridges and grooves, wherein prior to said inserting said flooring (100), filling the grooves of said corrugated surface with an adhesive, said adhesive for attaching said flooring (100) to said bottom.
